(19) United States
(12) Patent Application Publication
(10) Pub. No.: US 2008/0004179 A1
(43) Pub. Date: Jan. 3, 2008

(54) INOCULANT TOLERANT FUNGICIDAL COMPOSITIONS

(75) Inventors: Douthitt Pruitt Merritt, Greensboro, NC (US); Christian Schlatter, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 11/835,726

(22) Filed: Aug. 8, 2007

Related U.S. Application Data
(63) Continuation of application No. 10/204,116, filed on Aug. 15, 2002.

(51) Int. Cl. A01N 47/10; A01N 33/00; A01N 37/44; A01N 63/00; A01N 43/30; A01N 43/32

(52) U.S. Cl. 504/101; 514/422; 514/433; 514/476; 514/538; 514/646

(57) ABSTRACT

An inoculant tolerant, aqueous fungicidal composition, is provided which is substantially free of organic solvents, comprising a fungicidally effective amount of at least one fungicidally active compound; a stabilizing effective and nitrogen-fixing bacteria tolerant amount of a preservative; and at least one anionic surfactant. The composition is tolerant to nitrogen-fixing bacteria such as Rhizobium spp. when applied concurrently or sequentially to plant propagation materials such as seeds; the inventive compositions are storage stable, ready-to-apply (RTA), ecologically and toxicologically favorable and have good fungicidal efficacy.

### TECHNICAL FIELD

The present invention relates to inoculant tolerant, aqueous fungicidal compositions, the preparation of such compositions and a method of using such compositions to combat phytopathogenic fungi. The fungicidal compositions of the invention have particular application in the protection of plant propagation materials, such as seeds, against fungal disease.

### BACKGROUND OF THE INVENTION

The use of synthetic fungicides to control phytopathogenic fungi in crops is a wide spread practice. This practice has gained a high degree of commercial success because it has been shown that such control can increase crop yield. Fungicides typically are applied directly to plant propagation materials (such as seeds) prior to sowing and/or are used in foliar or furrow applications.

Another common practice used to increase crop yield is to inoculate seeds with an appropriate strain of nitrogen-fixing bacteria for the purpose of promoting plant growth. It is considered desirable for certain seeds to be inoculated with an effective bacterial strain such as Rhizobium spp. or Azospirillium spp. before sowing. The primary effect of such bacteria is in the fixation of atmospheric nitrogen into a useable form for the plant. Rhizobia bacteria, for example, form nodules on the plant roots and are sustained by the plant and in turn provide nitrogen for the plant as mentioned above.

Unfortunately, many fungicidal compositions may exhibit direct toxicity to the various strains of nitrogen-fixing bacteria when such compositions and bacteria are mixed together for seed treatment or when such compositions and bacteria are added to the seed sequentially.

There remains a need in the art for fungicidal compositions that may be effectively mixed with nitrogen-fixing bacteria, including sequential additions, for seed treatment.

### SUMMARY OF THE INVENTION

It has now been found that a storage stable, aqueous fungicidal composition, which is substantially free of organic solvents, comprising at least one fungicidally active compound and at least one anionic surfactant is tolerant to nitrogen-fixing bacteria such as Rhizobium spp. when applied concurrently or sequentially to plant propagation materials such as seeds; the inventive compositions are storage stable, ready-to-apply (RTA), ecologically and toxicologically favorable and have good fungicidal efficacy.

Accordingly, the present invention provides an inoculant tolerant, aqueous fungicidal composition, which is substantially free of organic solvents, comprising: a fungicidally effective amount of at least one fungicidally active compound; a stabilizing effective and nitrogen-fixing bacteria tolerant amount of a preservative; and at least one anionic surfactant.

In one embodiment, the preservative is present in the composition in an amount of from about 0 to about 0.05% by weight of the composition.

In one embodiment, the aqueous fungicidal composition is an aqueous solution.

The invention further provides for a method for preparing the fungicidal composition which is achieved by intimately mixing the components with water, optionally using a concentrated premix of the preservative and one or more formulation components, until a homogeneous phase is achieved.

The invention also provides for plant propagation materials treated with the fungicidal composition and for a method for reducing fungal infestation and for promoting the growth of plant propagation materials such as seeds. The method comprises contacting the seeds with the aqueous fungicidal composition described above either before, during or after addition of a plant growth-promoting amount of a nitrogen-fixing bacterium to the seed.

### DETAILED DESCRIPTION OF THE INVENTION

The term “fungicidally active compound” as utilized herein is intended to cover compounds active against phytopathogenic fungi that may belong to a very wide range of compound classes. Examples of compound classes to which the suitable fungicidally active compound may belong include: triazole derivatives, strobilurins, carbamates, benimidazoles (thiabendazole), N-trihalomethylthio compounds (captan), substituted benzenes, carboxamides, phenylamides and phenylpyrroles, and mixtures thereof.

Examples of suitable individual compounds of the above mentioned compound classes are listed below. Where known, the common name is used to designate the individual compounds (q.v. the Pesticide Manual, 11th edition, 1997, British Crop Protection Council).

Suitable triazole derivatives include propiconazole, difenconazole and tebuconazole.

Suitable strobilurins include trifloxystrobin, azoxystrobin and kresoxim-methyl.

Suitable carbamates include thiram.

Suitable substituted benzenes include PCNB and chlorothalonil.

Suitable carboxamides include carboxin.

A preferred phenylamide usable in the compositions and methods falling within the scope of the present invention include metalaxyl; metalaxyl consisting of more than 70% by weight of the R-enantiomer; metalaxyl consisting of more than 85% by weight of the R-enantiomer; metalaxyl consisting of more than 92% by weight of the R-enantiomer; metalaxyl consisting of more than 97% by weight of the R-enantiomer; and mefenoxam (i.e., R-metalaxyl or metalaxyl-M).

A specific phenylpyrrole usable in the compositions and methods falling within the scope of the present invention is fludioxonil.

The fungicidally active compounds are employed in a fungicidally effective amount in the composition.

Mixtures of one or more of the foregoing fungicidally active compounds also are usable as an active component in the practice of the present invention.

Preservatives useful in the practice of the invention include ascorbic acid, ascorbyl palmitate, benzoic acid, hexamethylenetetramine, propyl p-hydroxybenzoate, sodium propionate, sorbic acid (and potassium salt), sulfurous acid, 1,2-benzisothiazolin-3-one, 5-Chloro-2-methyl-4-isothiazolin-3-one (in combination with 2-methyl-4-isothiazolin-3-one), formaldehyde, magnesium nitrate (in combination with 2-meth-yl-4-isothiazolin-3-one and 5-chloro-2-methyl-4-isothiazolin-3-one), methyl p-hydroxybenzoate, 2-methyl-4-isothiazolin-3-one (in combination with 5-chloro-2-methyl-4-isothiazolin-3-one), paraformaldehyde, sodium o-phenylphenate, ascorbyl palmitate, benzoic acid, methyl-p-hydroxybenzoate (methyl paraben), propyl p-hydroxybenzoate (propyl paraben), and sodium benzoate.

Preservatives containing 1,2-benzisothiazolin-3-one are preferred.

The preservative is present in the fungicidal composition in a stabilizing effective and nitrogen-fixing bacteria tolerant amount. In one aspect, the preservative is present from 0 to about 0.05% by weight of the composition. More particularly, the preservative is present in an amount of from 0.005 to about 0.02% by weight, preferably 0.005 to 0.01% by weight.

The inoculent tolerant fungicidal compositions in accordance with the invention may take the form of aqueous solutions, dispersions, suspensions, emulsions or suspoemulsions. The composition is preferably a ready for use solution.

The aqueous composition of the invention is substantially free of organic solvents; i.e. the amount of organic solvent is less that 0.5%. Some commercially available materials may contain a small amount of organic solvent, which, when more than about 0.1% can be removed for example in a separator.

In particular, the aqueous composition of the invention is substantially free of nonaqueous solvents (0 to 0.5% by weight, preferably 0 to less than about 0.1% by weight). As organic, nonaqueous solvents there may be mentioned N-methyl-2-pyrrolidone and 1-octyl-2-pyrrolidone.

The ready-to-apply (RTA) aqueous compositions according to the invention are stable for at least 12 months at 25° C.

In one embodiment, the present invention provides an aqueous fungicidal composition, which is substantially free of organic solvents, comprising

a) a fungicidally effective amount of at least one fungicidally active compound,

b) a stabilizing effective and nitrogen-fixing bacteria tolerant amount of a preservative; and comprising as auxiliaries:
c1) at least one anionic surfactant; and
c2) at least one nonionic surfactant.

The composition optionally contains (d) at least one thickener.

Mixtures of at least one ambient liquid fungicide (for example, a phenylamide such as R-metalaxyl) and at least one ambient solid fungicide (for example, a phenylpyrrole such as fludioxonil) are preferred.

Advantageous mixing ratios of the phenyl amide (I) and phenylpyrrole (II) are I:II=from 10:1 to 1:30, preferably I:II=from 7:1 to 1:20. In many cases, mixtures in which the mixing ratio of the active substances I:II is from 7:1 to 1:10, e.g. from 7:1 to 1:1 are advantageous. Other advantageous mixing ratios are 6:1, 7:2, 2:3.

In one embodiment, the fungicidally active compound(s) is present in the composition in an amount of from about 0.5% to about 10% by weight.

Suitable auxiliaries include surfactants, thickeners and other agronomically acceptable auxiliaries and adjuvants employed in the pesticide formulation art.

Suitable anionic surfactants are in general oligomers and polymers, as well as polycondensates, which contain a sufficient number of anionic groups to ensure their water-solubility. Examples of suitable anionic groups are sulfo groups or carboxyl groups; but polymers containing carboxyl groups can only be used in the higher pH range, preferably at a pH higher than 5. The number of anionic groups per polymer molecule is usually at least 60% of the number of monomer units contributing to the structure of the molecule. Oligomers and polymers that contain sulfo groups can be prepared either by polymerising monomers that contain sulfo groups or by sulfonating the appropriate oligomers or polymers. Polymers that contain carboxyl groups can be obtained by saponifying polyacrylates or polymethacrylates, in which case the degree of saponification must be at least 60%. Particularly suitable anionic surfactants are sulfonated polymers and condensates of aromatic sulfonic acids with formaldehyde. Typical examples of such anionic surfactants are: Salts of polystyrenesulfonic acid, in particular the alkali metal, alkaline earth metal and ammonium salts, and the salts of organic amines which can be obtained by polymerising styrenesulfonic acid or salts thereof or by sulfonation of polystyrene and subsequent neutralisation with a suitable base, in which latter case the degree of sulfonation must be at least 60%.

Salts of polyvinylsulfonic acid, in particular the alkali metal, alkaline earth metal and ammonium salts, and the salts with organic amines which can be obtained by polymerising vinylsulfonic acid or salts therof. Salts of condensates of naphthalene-sulfonic acids, preferably naphthalene-2-sulfonic acid, with formaldehyde, in particular the alkali metal, alkaline earth metal and ammonium salts, and salts thereof with organic amines which can be obtained by sulfonation of naphthalene, condensation of the resultant naphthalenesulfonic acids with formaldehyde, and neutralisation with a suitable base. The molecular weight of these compounds is in the range from about 500 to 60%.

Salts of condensates of naphthalenesulfonic acid with phenolsulfonic acid and formaldehyde, in particular the alkali metal, alkaline earth metal and ammonium salts, and salts with organic amines. These products are sulfo group containing polymers with an average molecular weight of 6000 to 8000, in which the monomer units naphthalene and phenol are linked to each other partly through methylene groups and partly through sulfo groups.

Salts of ligninsulfonic acid, in particular the sodium, potassium, magnesium, calcium or ammonium salt. Prefered anionic surfactants include α-[2,4,6-tris[1-(phenyl)ethyl]phenyl]-ω-hydroxypolyoxy(ethylene), mixture of monohydrogen and dihydrogen phosphate esters, such as those having a poly(oxyethylene) content of from about 4 to about 150 moles. Suitable anionic surfactants can be prepared by methods known per se and also are commercially available.

In one aspect, the anionic surfactant(s) is present in the composition in an amount of from about 0.3% to about 5% by weight.

It may be advantageous to add additionally a nonionic surfactant and a thickener to the aqueous fungicidal composition.

Suitable nonionic surfactants, when present, are in general nonionic water-soluble polymers having an average molecular weight of below 20,000. Particularly suitable nonionic surfactants of this kind are the products which can be obtained by reaction of ethylene oxide, or by the combined reaction of ethylene oxide and propylene oxide, with fatty alcohols, alkylphenols, fatty acids, fatty acid esters of polyhydroxy compounds, fatty acid amides and fatty amines, where the number of ethylene oxide and propylene oxide units may vary within wide limits. In general, the number of ethylene oxide units or ethylene oxide and propylene oxide units is from 1 to 200, preferably from 5 to 100 and, most preferably, from 8 to 40.

Preferred nonionic sufactants include α-butyl-ω-hydroxypropyl-(oxypropylene) block polymers with poly(oxyethylene) such as those with a molecular weight of from 2400 to 3500, and α-[2,4,6-tris[1-(phenyl)ethyl]phenyl]-ω-hydroxypolyoxy(ethylene) such as those having a poly(oxyethylene) content of from about 4 to about 150 moles. Suitable nonionic surfactants can be prepared by methods known per se and also are commercially available.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, hydroxypropyl cellulose, hydroxypropyl guar gum, and sodium carboxymethylcellulose. Xanthan gum is preferred.

The aqueous composition according to the invention can be employed together with the adjuvants customary in formulation technology, further carriers, surfactants (cationic, anionic, nonionic, amphoteric), emulsifiers (lethicin, sorbitan, and the like), antifreeze agents (glycerin), dyes, antifoam agents or application-promoting adjuvants customarily employed in the art of formulation. In addition, there may be mentioned inoculants, brighteners and polymers.

The inventive compositions contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

In particular, sodium molybdate is mentioned as an additional fungicidally active ingredient.

The aqueous fungicidal compositions of the invention can be prepared by a process which comprises the steps: (a) forming a premix with a preservative and (i) at least one fungicidally active compound and/or (ii) at least one formulation auxiliary, wherein the preservative in the premix is at a concentration that is toxic to nitrogen-fixing bacteria; (b) diluting the premix of step (a) with water while concurrently or sequentially adding the remaining ingredients; and (c) stirring the mixture to form a homogeneous composition, wherein the preservative is present in the final composition in a stabilizing effective and nitrogen-fixing bacteria tolerant amount.

Advantageously, step (b) is carried out sequentially to allow a homogenous precursor composition to be achieved before the additional component(s) are added.

In one aspect, solid fungicidally active compounds may be milled prior to being added.

The final composition can be screened to remove any insoluble particles.

Suitable concentrations of the components in relation to the total weight of the aqueous fungicidal composition comprise:

1) of the fungicidally active compound or mixture of compounds: 0.5 to 10%, preferably 0.1 to 5%, more preferred 0.5 to 2% fungicidally active compounds in relation to the total composition;

2) of the surfactants: 0.5 to 20%, including 0.3 to 5% of an anionic surfactant; and

3) of the preservative: 0 to about 0.05%, preferably 0.005 to about 0.02% by weight, more preferred 0.005 to 0.01% by weight.

The aqueous fungicidal compositions of the invention are formulated for protecting cultivated plants and their propagation materials. The inventive compositions are advantageously formulated for seed treatment applications against diseases in the soil, which mostly occur in the early stages of plant development. For example, the compositions can be formulated to target pathogens including Pythium, Tilletia, Gerlachia, Septoria, Ustilago, Fusarium, Rhizoctonia (so-called “damping off complex”); Oomycetes such as Phytophthora, Plasmopara, Pseudoperonospora, Bremia etc. as well as against the Botrytis species, Pyrenophora, Monilinia and further representatives of the Ascomycetes, Deuteromycetes and Basidiomycetes classes.

Suitable target crops are especially potatoes, cereals, (wheat, barley, rye, oats, rice), maize, sugar beet, cotton, millet varieties such as sorghum, sun flowers, beans, peas, oil plants such as rape, soybeans, cabbages, tomatoes, eggplants (aubergines), pepper and other vegetables and spices as well as ornamental shrubs and flowers.

The inventive compositions are particularly suited for dressing applications on plant propagation material. The latter term embraces seeds of all kinds (fruit, tubers, grains), cuttings, cut shoots and the like. The preferred field of application is the treatment of all kinds of seeds (as specified in the target crops above), and in particular the seed treatment of soybeans and other legumes and crops that are susceptible to Rhizobium symbiosis that results from the deliberate coating of a legume seed with the appropriate Rhizobium spp. prior to planting.

The techniques of seed treatment application are well known to those skilled in the art, and they may be used readily in the context of the present invention. The aqueous fungicidal composition of the invention is applied to the seed as slurry or a soak. There also may be mentioned, e.g., film coating or encapsulation. The coating processes are well known in the art, and employ, for seeds, the techniques of film coating or encapsulation, or for the other multiplication products, the techniques of immersion. Needless to say, the method of application of the inventive compositions to the seed may be varied and the invention is intended to include any technique that is to be used.

A preferred method of applying the aqueous fungicidal composition according to the invention consists in spraying or wetting the plant propagation material with the aqueous liquid preparation, or mixing the plant material with such liquid preparation.

As noted above, the compositions of this invention may be formulated or mixed in the seed treater tank or combined on the seed by overcoating with other seed treating agents. The agents to be mixed with the compounds of this invention may be for the control of pests, nutrition, the control of plant diseases, or for the modification of plant growth, especially with nitrogen-fixing bacteria.

The inventive aqueous fungicidal composition has particular application to concurrent (such as by slurry) and sequential seed treatments with a plant growth promoting amount of a nitrogen-fixing bacteria including Rhizobia spp. Suitable Rhizobia formulations can be prepared by methods known per se and also are commercially available. Among the suitable Rhizobia formulations there may be mentioned Cell-Tech 2000™ available from Lipha Tech (Milwaukee Wis.).

### EXAMPLES

The following non-limiting Examples illustrate the invention in more detail.

### Preparation Example

The registered trademarks and other designations denote the following products:

| | |
|---|---|
| Soprophor BSU (Rhodia) | α-[2,4,6-tris[1- |
| | (phenyl)ethyl]phenyl]-ω- |
| | hydroxypolyoxy(ethylene) |
| Soprophor 3D-33 (Rhodia) | α-[2,4,6-tris[1- |
| | (phenyl)ethyl]phenyl]-ω- |
| | hydroxypolyoxy(ethylene), |
| | mixture of monohydrogen and |
| | dihydrogen phosphate esters |
| Witconol NS 500LQ (Witco) | α-butyl-ω-hydroxypropyl- |
| | (oxypropylene) block polymer with |
| | poly(oxyethylene) |
| Rhodopol 23 (Rhodia) | Xanthan Gum |
| Proxel GXL (Zeneca) | Preservative containing 1,2- |
| | benzisothiazolin |

% WT of the total composition. The components are intimately mixed until a homogeneous phase is achieved.

### Example 1

| % WT | Component | Type |
|---|---|---|
| 0.77 | Fludioxonil | Fungicide |
| 1.11 | Mefenoxam (R-metalaxyl) | Fungicide |
| 10.80 | Glycerin | Antifreeze |
| 0.69 | Soprophor BSU | Nonionic surfactant |
| 0.65 | Soprophor 3D-33 | Anionic surfactant |
| 0.39 | Witconol NS 500LQ | Nonionic surfactant |
| 0.03 | Antifoam A (Dow Corning) | Defoaming agent |
| 0.22 | Rhodopol 23 | Thickener |
| 0.02 | Proxel GXL | Preservative |
| 3.00 | FD&C Blue #1 | Dye |
| 82.32 | Water | Solvent |

### Biological Example

Soybean nodulation is evaluated at 37 days after planting. The data was analyzed at a 5% level, CV=28.3%, LSD=3.359.

| Treatment | Nodules per Plant | Mean Separation |
|---|---|---|
| a) Rhizobia (Cell-Tech 2000) | 12.5 | A |
| b) Example 1 (slurry w/A) | 12.2 | AB |
| c) Uninoculated | 3.4 | EF |

Although the foregoing invention has been described in some detail by way of illustration and example for purposes of clarity of understanding, it will be apparent that various changes and modifications may be practiced within the scope of the appended claims.

1-17. (canceled)

18. A method for reducing fungal infestation of plants, parts of plants, and seeds, and for promoting plant growth, which comprises contacting plant propagation material with a fungicidally effective amount of an inoculant tolerant, aqueous fungicidal composition, which is substantially free of organic solvents, comprising:
a) a fungicidally effective amount of at least one fungicidally active compound;
b) a stabilizing effective and nitrogen-fixing bacteria tolerant amount of a preservative; and
c) at least one anionic surfactant; and
inoculating said plant propagation material in any desired sequence, simultaneously or in succession, with a plant growth promoting effective amount of a nitrogen-fixing bacterium.

19. A method according to claim 18, wherein the fungicidally active compound belongs to a class selected from the group consisting of triazole derivatives, strobilurins, carbamates, benimidazoles, N-trihalomethylthio compounds, substituted benzenes, carboxamides, phenylamides and phenylpyrroles.

20. A method according to claim 18, wherein the fungicidally active compound is selected from the group consisting of thiram, PCNB, chlorothalonil, carboxin, metalaxyl, and fludioxonil.

21. A method according to claim 18, wherein the fungicidally active compound is present in the composition in an amount of from about 0.5% to about 10% by weight of the total composition.

22. A method according to claim 18, wherein the anionic surfactant is present in the composition in an amount of from about 0.3 to 5% by weight of the total composition.

23. A method according to claim 18, wherein the preservative is present in the composition in an amount of from about 0.005 to about 0.02% by weight of the total composition.

24. A method according to claim 23, wherein the preservative contains 1,2-benzisothiazolin-3-one.

25. A method according to claim 18, which further comprises at least one nonionic surfactant.

26. A method according to claim 18, which further comprises at least one at least one thickener.

27. A method according to claim 18, wherein the fungicidally active component a) comprises at least one ambient liquid fungicide and at least one ambient solid fungicide.

28. A method according to claim 27, wherein the ambient liquid fungicide is metalaxyl consisting of more than 92% by weight of the R-enantiomer.

29. A method according to claim 27, wherein the ambient solid fungicide is fludioxonil.

30. A method according to claim 18 wherein said plant propagation material comprises soybean seed.

31. A method according to claim 18 wherein said nitrogen-fixing bacteria comprises a Rhizobium spp. bacterium.

32. A method according to claim 18, wherein the fungicidally active compound is metalaxyl consisting of more than 92% by weight of the R-enantiomer.

33. A method according to claim 18, wherein the fungicidally active compound is R-metalaxyl.

34. An inoculant tolerant, aqueous fungicidal composition, which is substantially free of organic solvents, comprising:
a) a fungicidally effective amount of at least one fungicidally active compound;
b) a stabilizing effective and nitrogen-fixing bacteria tolerant amount of a preservative; and
c) at least one anionic surfactant.

35. The composition according to claim 34, wherein the fungicidally active compound belongs to a class selected from triazole derivatives, strobilurins, carbamates, benimidazoles, N-trihalomethylthio compounds, substituted benzenes, carboxamides, phenylamides and phenylpyrroles.

36. The composition according to claim 34, wherein the fungicidally active compound is selected from the group consisting of thiram, PCNB, chlorothalonil, carboxin, metalaxyl, and fludioxonil.

37. The composition according to claim 34, wherein the fungicidally active compound is present in the composition in an amount of from about 0.5% to about 10% by weight of the total composition.

38. The composition according to claim 34, wherein the anionic surfactant is present in the composition in an amount of from about 0.3 to 5% by weight of the total composition.

39. The composition according to claim 34, wherein the preservative is present in the composition in an amount of from about 0.005 to about 0.02% by weight of the total composition.

40. The composition according to claim 40, wherein the preservative contains 1,2-benzisothiazolin-3-one.

41. The composition according to claim 34, which further comprises at least one nonionic surfactant.

42. The composition according to claim 34, which further comprises at least one at least one thickener.

43. The composition according to claim 34, wherein the fungicidally active component a) comprises at least one ambient liquid fungicide and at least one ambient solid fungicide.

44. The composition according to claim 43, wherein the ambient liquid fungicide is R-metalaxyl.

45. The composition according to claim 43, wherein the ambient liquid fungicide is metalaxyl consisting of more than 92% by weight of the R-enantiomer.

46. The composition according to claim 43, wherein the ambient solid fungicide is fludioxonil.

47. The composition according to claim 43, wherein the ambient liquid fungicide is R-metalaxyl and the ambient solid fungicide is fludioxonil.

48. Plant propagation material treated with the composition according to claim 34.

49. The plant propagation material according to claim 48 comprising soybean seed.

50. The composition according to claim 34, wherein the nitrogen-fixing bacteria comprises a Rhizobium spp. bacterium.
